(19) United States
(12) Patent Application Publication
(10) Pub. No.: US 2020/0005223 A1
(43) Pub. Date: Jan. 2, 2020

(54) Methods of Establishing Safety Stock Levels

(71) Applicant: Right Sized Inventory, Corrales, NM (US)

(72) Inventor: Stephen Cook, Albuquerque, NM (US)

(21) Appl. No.: 16/023,389

(22) Filed: Jun. 29, 2018

(51) Int. Cl. G06Q 10/08; G06Q 30/02

(52) U.S. Cl. CPC G06Q 10/087; G06Q 30/0202

(57) ABSTRACT

In an approach to handling a plurality of heuristics to establish safety stock limits using genetic algorithms, a product genome evaluation engine generates a first product genome from a population of products, identifies a safety stock objective, and identifies multiple products associated with the safety stock objective. The product genome evaluation assigns a product heuristic byte that defines product heuristics that can be applied to each product of the multiple products to the first product genome, assigns a product heuristic that defines at least one inventory policy from the product heuristics to the each product at random, and applies each product heuristic associated with the each product. Based on the overall effect of the product heuristics on each product, the product genome evaluation engine establishes safety stock limits for each product and determines whether the safety stock limits achieve the safety stock objective.

### FIELD OF THE INVENTION

The field of the invention is establishing safety stock levels.

### BACKGROUND

Safety stock levels describe a level of extra stock that is maintained to mitigate the risk of a shortfall in raw material, packaging, and/or products due to uncertainties in supply and demand. Maintaining adequate safety stock levels is crucial in many business operations such as manufacturing and retail businesses.

When a company has a number of products that must be maintained at adequate safety stock levels, an employee typically estimates safety stock levels based on historical sales data. However, there are many different priorities that can be associated with establishing safety stock levels. Safety stock levels for inventory with unique attributes might be best established if particular heuristics are prioritized over others. For example, a store selling a highly anticipated video game can establish an optimal safety stock strategy by focusing on forecasted demand. On the other hand, the store could also establish an optimal safety stock strategy for gaming accessories in steady and constant demand by focusing on monthly sales figures. In order optimize safety stock strategies for each product, however, the company will likely have to invest significant resources, such as time and money, to determine which combination of stock level strategy and product pairs best achieves a desired objective. In many cases, the number of combinations of particular products and safety stock priorities is often too numerous to test all the combinations.

By using genetic algorithms to establish safety stock levels, product genomes can be selectively recombined with each other based on an overall value score and/or specific strengths of particular product genomes. Overall value scores can be determined relative to an overall objective. For example, a product genome resulting in a low risk of unsold inventory might score highly if the overall objective is to minimize losses, but may also score much lower if the overall objective is to maximize profits. Specific strengths of product genomes can include traits that are a product of the particular combination of safety stock strategies with each item, such as low risk of stockout and low risk of unsold inventory. By selectively recombining the highest scoring genomes, an optimized product genome can be discovered far more quickly than through conventional methods.

Thus, there is still a need for safety stock supply systems enhanced with genetic algorithms.

### SUMMARY OF THE INVENTION

Among other things, the inventive subject matter provides a method in which a genetic algorithm recombines, and mutates product genomes associated with product heuristics (e.g., safety stock strategies) in order to achieve a desired safety stock system. As used herein, a “resource” is any resource, whether physical or virtual, living or nonliving. Examples include a room, a building, a consumable item, a portable tool, a piece of equipment that is fixed to a location, a person, or an animal. Each resource typically has a series of unique and non-unique attributes that are associated with the resource. As the terms imply, unique attributes are attributes that are unique to that particular resource, and non-unique attributes are attributes that can be common by more than one resource. As used herein, products and their associated product heuristics act as individual genes that are compiled into a product genome for possible recombination or mutation.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a method of determining a value score for a product genome based on a product heuristic assigned to each product of the genome.

FIG. 2 is a schematic of a method of recombining two product genomes into a recombined product genome and determining a value score for the recombined product genome.

FIG. 3 is a schematic of a method of randomly mutating a product in a genome and determining a value score for the mutated product genome.

FIG. 4 illustrates the recombination of two product genomes based on randomly selected crossover points.

FIG. 5 illustrates the recombination of two product genomes with a product heuristic byte based on randomly selected crossover points.

FIG. 6 illustrates the mutation of a product genome based on randomly selected product.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including optimizing safety stock strategy where the permutations of safety stock strategy are too numerous to efficiently determine using known strategies.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

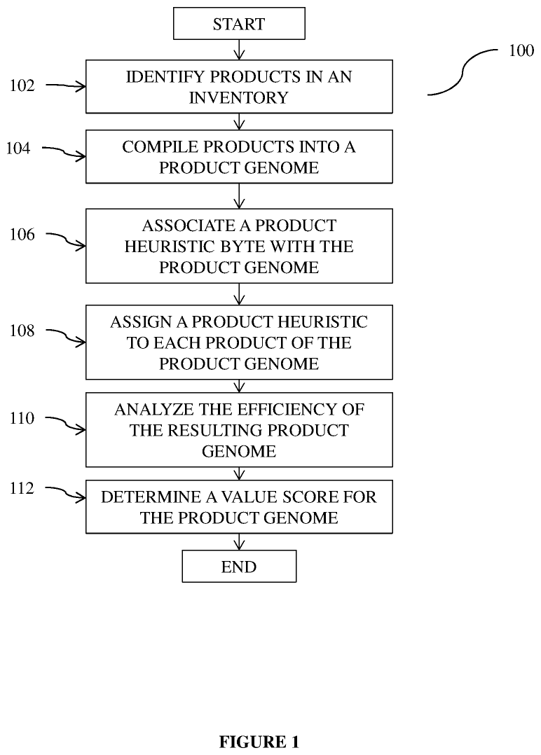

FIG. 1 is a schematic of product genome evaluation engine 100 of determining a value score for a product genome based on a product heuristic assigned to each product of the product genome.

Product genome evaluation engine 100 identifies one or more products in an inventory (step 102). For example, product genome evaluation engine 100 can identify each product in a retail inventory list. In another example, product genome evaluation engine 100 identifies each raw material used in a manufacturing plant. It is contemplated that product genome evaluation engine 100 can identify any type of inventory in any system.

Product genome evaluation engine 100 compiles the products into a product genome (step 104). Product genome evaluation engine 100 compiles the products, which act as genes, into a product genome randomly or subject to additional variables. For example, product genome evaluation engine 100 compiles a product genome where products are grouped closer together in the product genome based on shared traits, such as a technological ecosystem associated with a brand of products. By grouping similar products in closer proximity to one another in the product genome, subsequent recombination or mutation of the product genome will be less likely to create dramatic changes in interrelated products. On the other hand, product genome evaluation engine 100 compiles a product genome where the products are distributed in a way that attempts to minimize grouping based on similar traits in order to quicken the evolution of the product genome.

Product genome evaluation engine 100 associates a product heuristic byte with the genome (step 106). A product heuristic byte is a collection of different inventory policies that can be associated with each product. In one example, a product heuristic byte contains the following inventory policies in a retail setting: prioritize maximum sales, prioritize minimal stockout, and prioritize demand forecast. However, inventory policies are not binary in nature, and include additional qualifiers, such as “in the upper 50^{th} percentile of sales” and “between the 25^{th} and 75^{th} percentile of stockout risk”. It is contemplated that the product heuristics can comprise any qualifiers that add an additional variable affecting the inventory policy of each product. Inventory policies allow a program or individual to determine stock supply limits.

Product genome evaluation engine 100 assigns a product heuristic from the product heuristic byte to each product of the product genome (step 108). Product genome evaluation engine 100 preferably assigns a product heuristic byte to each product of the genome at random. In alternative embodiments, product genome evaluation engine 100 limits and/or expands the assignable product heuristics based on the particular product. For example, product genome evaluation engine 100 can be programmed to not pick product heuristics associated with demand forecasting for products that have a substantially consistent demand.

Product genome evaluation engine 100 analyzes the efficiency of the resulting product genome (step 110). It is contemplated that product genome evaluation engine 100 can analyze the efficacy of each product genome in achieving the overall stock supply objective. For example, product genome evaluation engine 100 can analyze historical stock supply data for each product/heuristic pair collected over the course of a month to determine if the product genome results in maximum sales.

Product genome evaluation engine 100 determines a value score of the product genome (step 114). A value score indicates the overall success of a product genome in achieving one or more stock supply objectives, which can include maximizing sales, minimizing stockout, and accurately forecasting demand.

Product genome evaluation engine 100 preferably determines a value score using a fitness function. A fitness function is a particular type of objective function that is used to summarize, as a single figure of merit, how close a given solution is achieving the set aims. Once product genome evaluation engine 100 determines the value score of a product genome, the genome can be discarded, mutated, or recombined with other genomes.

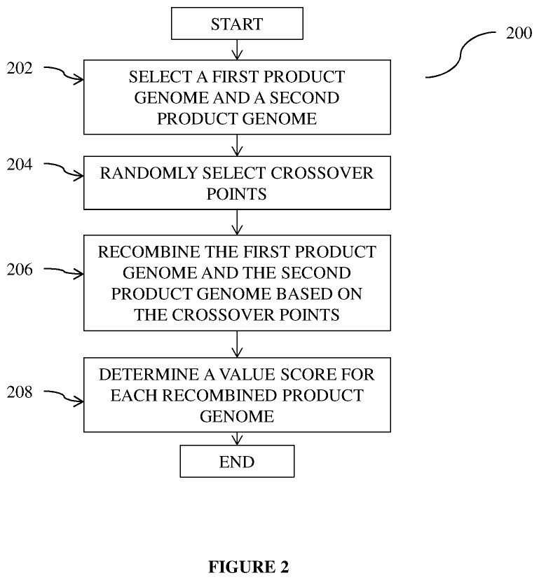

FIG. 2 is a schematic of a method of recombining two product genomes into a recombined product genome and determining a value score for the recombined product genome.

Product genome recombination engine 200 selects a first product genome and a second product genome (step 202). It is contemplated that product genome recombination engine 200 selects the first product genome and the second product genome based on their respective value scores. In some embodiments, product genome recombination engine 200 selects the first product genome and the second product genome based on value scores meeting a similarity threshold. For example, product genome recombination engine 200 can be programmed to select the two highest scoring product genomes out of one hundred genomes to be recombined. In another embodiment, product genome recombination engine 200 selects the first product genome and the second product genome based their value scores meeting a dissimilarity threshold. For example, product genome recombination engine 200 can select a first product genome with the highest sub-score in minimizing stockouts with a second product genome with the highest sub-score in minimizing unsold inventory.

Product genome recombination engine 200 randomly selects one or more crossover points (step 204). Crossover points are points in a product genome between products that are mirrored in both a first and a second genome. For example, a first product genome and a second product genome must have the same composition of products in the each product genome and be represented in the same order. The first product genome and the second product genome can also have different inventory policies tied to each product in the form of a product heuristic.

Product genome recombination engine 200 preferably selects one or more crossover points at random. Selecting the one or more crossover points at random increases the genetic variability in the recombined offspring of two product genomes. Product genome recombination engine 200 can also select one or more crossover points based on preset parameters. For example, product genome recombination engine 200 can select from 15 predetermine recombination sites shared by each genome in order to increase the genetic variability of the system while preventing groups of related products/genes from evolving separately.

Product genome recombination engine 200 recombines the first product genome and the second product genome at the one or more crossover points (step 206). The first product genome and the second product genome switch portions of each respective genome at the one or more crossover points. For example, if a first genome comprising the products A₁, B₁, C₁, and D₁ in that order is recombined with a second genome comprising the products A₂, B₂, C₂, and D₂ in that order between products “A” and “B” and between products “C” and “D”, then the recombined genomes would produce a first recombined genome comprising A₁, B₂, C₂, and D₁ and a second recombined genome comprising A₂, B₁, C₁, and D₂.

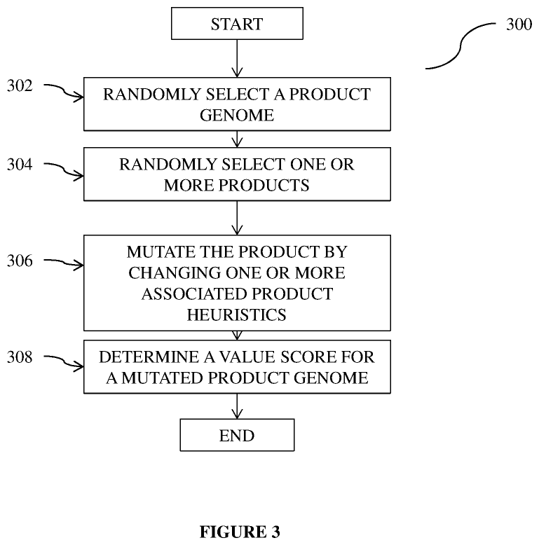

FIG. 3 is a schematic of a method of randomly mutating a product in a product genome and determining a value score for the mutated genome.

Product genome mutation engine 300 randomly selects a product genome (step 302). Alternatively, product genome mutation engine 300 can be directed to select product genomes fitting one or more parameters. For example, product genome mutation engine 300 can be programmed to select a product genome at random from a group of genomes that at least have value scores above the 80^{th} percentile.

Product genome mutation engine 300 randomly selects one or more products associated with one or more product heuristics (step 304). Product genome mutation engine 300 can alternatively select one or more products based on one or more parameters. For example, product genome mutation engine 300 can be limited to only selecting products that are compatible with product heuristics related to stockout risk. It is preferred, however, that product genome mutation engine 300 selects the one or more products at random.

Product genome mutation engine 300 mutates the one or more products by randomly changing the one or more product heuristics (step 306). Product genome mutation engine 300 can alternatively mutate the one or more products subject to a parameter. For example, product genome mutation engine 300 can be programmed to avoid mutating product heuristics associated with forecasting demand in products that are in constant demand, such as consumable products like batteries, toilet paper, and toothpaste.

Product genome mutation engine 300 determines a value score of the product genome (step 308). The value score indicates the overall success of a mutated product genome in achieving one or more stock supply objectives, which can include maximizing sales, minimizing stockout, and accurately forecasting demand. Product genome mutation engine 300 preferably determines a value score using a fitness function. A fitness function is a particular type of objective function that is used to summarize, as a single figure of merit, how close a given solution is achieving the set aims. Once product genome mutation engine 300 determines the value score of a mutated product genome, the mutated product genome can be discarded, further mutated, or further recombined with other genomes. A value score can comprise multiple value sub-scores covering a variety of quantifiable traits.

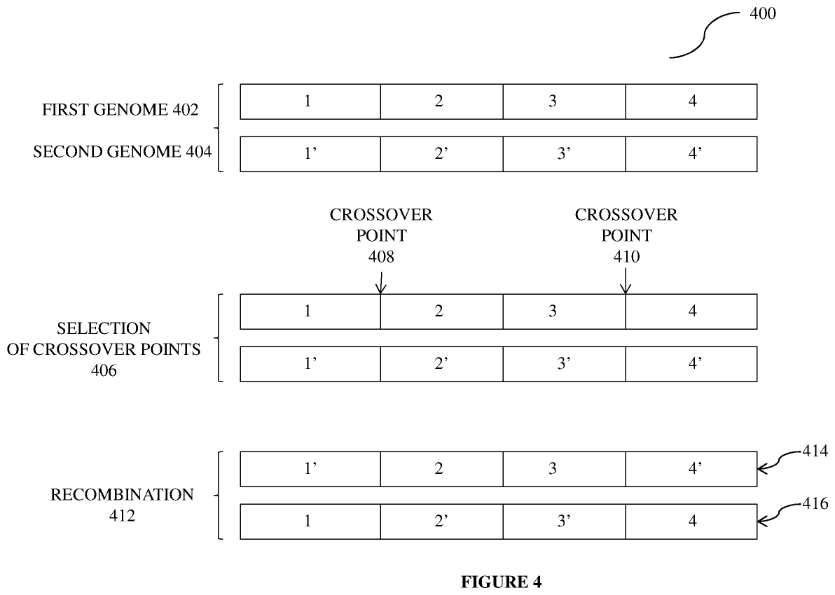

FIG. 4 illustrates the recombination of first genome 402 and second genome 404 based on selected crossover points.

First genome 402 and second genome 404 comprise any two product genomes with an identical ordering of products such that the two genomes are mirror images of each other except for the product heuristics assigned to each product. For example, product/gene 1 in first genome 402 and product/gene 1′ in second genome 404 are the same product, but are stocked according to different inventory policies.

Selection of crossover points 406 occurs when product genome recombination engine 400 selects crossover point 408 and crossover point 410 at random. Crossover points represent points between products where two product genomes exchange segments of their product inventories, which are represented as an ordered collection of genes in a product genome. In the depicted embodiment, product genome recombination engine 400 selects a crossover point between product 1 and product 2 and selects a second crossover point between product 3 and product 4. Recombination 412 occurs when the product genomes, represented by first genome 402 and second genome 404, are recombined at crossover points. In the depicted embodiment, first genome 402 and second genome 404 are recombined at crossover point 408 and crossover point 410 to create first recombined product genome 414 comprising products 1′/2/3/4′ and second recombined genome 416 comprising products 1/2′/3′/4.

In alternative embodiments, selection of crossover points 406 is not at random. Instead selection of crossover points 406 is predetermined by an algorithm or by one or more users. For example, a user can program product genome recombination engine 400 to avoid selecting crossover points in particular gene sequences in order to preserve groups of related products that should evolve together, such as interrelated products from the same brand.

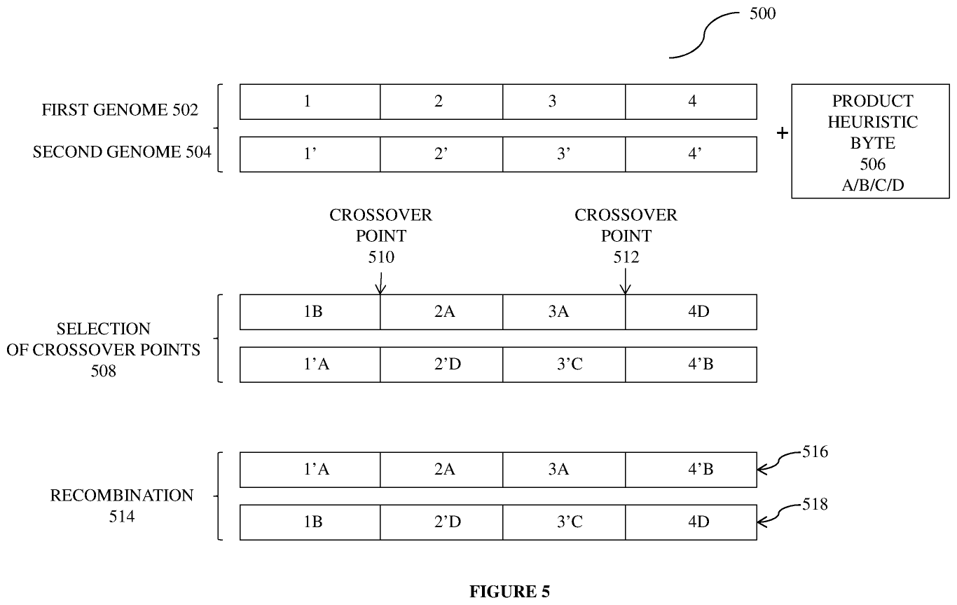

FIG. 5 illustrates the recombination of two product genomes with a product heuristic byte based on randomly selected crossover points.

First genome 502 and second genome 504 comprise any two product genomes with identical ordering of products such that the two product genomes are mirror images of each other except for the product heuristics assigned to each product. For example, product/gene 1 in first genome 502 and product/gene 1′ in second genome 504 are the same product, but are stocked according to different inventory policies.

Product heuristic byte 506 is coupled with every genome. Product heuristic byte 506 preferably assigns a product heuristic to each product in each product genome at random. In some embodiments, product heuristic byte 506 assigns a product heuristic to each product at random. Product genome recombination engine 500 can alternatively be programmed to not assign particular product heuristics from product heuristic byte 506 to certain products. For example, product genome recombination engine 500 can be programmed to avoid assigning product heuristics related to forecasting demand where the demand for the product is substantially invariable.

In the depicted embodiment, product heuristic byte 506 comprises four product heuristics represented by “A”, “B”, “C”, and “D”. Product genome recombination engine 500 selects one of the four product heuristics at random as assigns them to each product of first genome 602 and second genome 604.

Selection of crossover points 508 occurs when product genome recombination engine 500 selects crossover point 510 and crossover point 512 at random. Crossover points represent points between products where two product genomes exchange segments of their product inventories, which are represented as an ordered collection of genes in a product genome. In the depicted embodiment, product genome recombination engine 500 selects a crossover point between product 1 and product 2 and selects a second crossover point between product 3 and product 4. Recombination 514 occurs when the product genomes, represented by first genome 402 and second genome 404, are recombined at crossover points. In the depicted embodiment, first genome 502 and second genome 504 are recombined at crossover point 510 and crossover point 512 to create first recombined genome 516 comprising products and associated product heuristics 1′A/2A/3A/4′B and second recombined genome 518 comprising products and associated product heuristics 1B/2′D/3′C/4D.

In alternative embodiments, selection of crossover points 508 is not at random. Instead, selection of crossover points 508 can be predetermined by an algorithm or by one or more users. For example, a user can program product genome recombination engine 500 to avoid selecting crossover points in particular gene sequences in order to preserve groups of related products that should evolve together, such as interrelated products from the same brand.

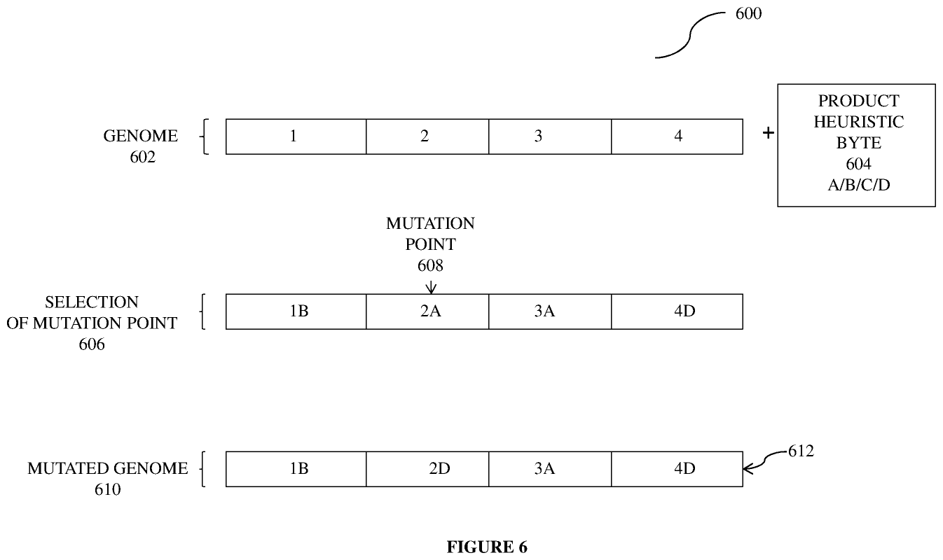

FIG. 6 illustrates the mutation of a product genome based on randomly selected product. Genome 602 is coupled with product heuristic byte 604, which preferably assigns a product heuristic to each product at random.

Selection of mutation point 606 occurs when mutation engine 600 selects mutation point 608 at random. Mutation points indicate one or more products to be randomly mutated by changing the one or more product heuristics associated with each product. In the depicted embodiment, mutation engine 600 selects product 2 as mutation point 608. Mutation engine 600 randomly mutates the product heuristic “A” associated with product 2 to “D”.

Over many cycles of recombination and subjecting product genomes to fitness evaluations, the method achieving an overall objective is continuously refined to eventually yield the most effective inventory policy tailored to each unique combination of products. Applying genetic algorithms to inventory policies automates the decision-making process by using the principles of genetic recombination and evolution and related fitness functions to evolve the most effective way of achieving an overall stock supply objective.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for handling a plurality of heuristics to establish safety stock limits using a genetic algorithm, comprising:
generating a first product genome from a population of products;
identifying a safety stock objective;
identifying at least first and second products associated with the safety stock objective;
assigning a product heuristic byte that defines product heuristics that can be applied to each of the first and second products in the first product genome;
assigning a first product heuristic to the first product and a second product heuristic to a second product that defines at least one inventory policy from the product heuristics to each of the first product and the second product at random;
applying each product heuristic associated with each of the first product and the second product;
establishing safety stock limits based on an overall effect of the product heuristics applied to the each of the first product and the second product; and
determining whether the safety stock limits achieve the safety stock objective.

2. The method of claim 1, wherein the at least one inventory policy is selected from the group consisting of: a demand, a lead time, a service level, and a forecast error.

3. The method of claim 1, assigning the product heuristic byte to the first product genome further comprises assigning a gene to each product of the first product genome that specifies the product heuristic.

4. The method of claim 1, further comprising:
identifying a second product genome associated with the product heuristics;
selecting one or more products at random;
associating each product of the one or more products with a product heuristic that comprises at least one inventory policy at random;
switching the placement of the one or more products between the first product genome and the second product genome to create a recombined product genome, the each product being present in both the first product genome and the second product genome; and
determining whether a new combination of product heuristics associated with the recombined product genome achieve the safety stock objective.

5. The method of claim 1, further comprising:
selecting a product at random;
determining the product heuristic and associated with the product;
changing the product heuristic at random to create a mutated product; and
integrating the mutated product into the first product genome in place of the product.

6. The method of claim 1, wherein the safety stock objective is to minimize unsold inventory.

7. The method of claim 4, further comprising updating the safety stock limits on a continuous and intermittent basis if the safety stock limits do not achieve the safety stock objective.
